(19) United States
(12) Patent Application Publication
(10) Pub. No.: US 2006/0003753 A1
(43) Pub. Date: Jan. 5, 2006

(54) Method of Identifying Media Content Contemporaneous with Broadcast

(76) Inventor: John F. Baxter JR., Marco Island, FL (US)

Correspondence Address: SMITH & HOPEN PA, 15950 BAY VISTA DRIVE, SUITE 220, CLEARWATER, FL, 33760, US

(21) Appl. No.: 10/711,241

(22) Filed: Sep. 3, 2004

Related U.S. Application Data
(63) Continuation-in-part of application No. 10/605,202, filed on Sep. 15, 2003.
(60) Provisional application No. 60/521,400, filed on Apr. 19, 2004.

(51) Int. Cl. H04Q 7/20

(52) U.S. Cl. 455/414.3; 455/418

(57) ABSTRACT

A method of identifying a music recording substantially contemporaneously with the broadcast of the music recording including the steps of: establishing a music recording broadcast database whereby music recordings are identified by an automated software process as music recordings are broadcast from a plurality of different stations; receiving a request for the music recording substantially contemporaneous with its broadcast by a telephone call, the request comprising a station field established by DNIS and a requester identity field established by CID; generating a timestamp value associated with the time the request was received; querying the music recording broadcast database using the station field and the timestamp value to identify the music recording; and returning the query results to a destination associated with the requestor identity field.

### PRIORITY CLAIM

This invention claims priority to U.S. patent application Ser. No. 10/605,202 filed Sep. 15, 2003 entitled “Audio Content Distribution System” and to U.S. Provisional Patent Application No. 60/521,400 filed Apr. 19, 2004 entitled “Audio Content Distribution System.”

### FIELD OF INVENTION

This invention relates to a system for identifying and distributing media content requested contemporaneously to the broadcast of the content.

### BACKGROUND OF THE INVENTION

Radio technology has proliferated for more than a century. In December 1894, Guglielmo Marconi invented his spark transmitter with antenna at his home in Bologna, Italy. He took his “Black Box” to Britain in February 1896 and filed for British Patent Number 12,039 on Jun. 2, 1896. He formed his first Wireless Telegraph and Signal Company in Britain in 1897 at age 23 and the world's first radio factory the following year. The American Marconi Company was formed in 1899. Marconi controlled patents for the Lodge tuner of 1900, and Fleming valve of 1904 that acted as a diode tube to amplify electrical current in one direction.

Through the following decades, radio experienced its “Golden Years” only to be eclipsed, but not replaced, by television. As the Internet evolved, it became clear it was a superior vehicle for delivering audio content to end users. To the dismay of copyright holders, peer-to-peer networks proliferated, enabling users to exchange high quality music outside the traditional distribution mediums. Industry groups representing the interests of the content creators have been forced to engage in heavy-handed tactics such as suing individual users that illegally exchanged copyrighted content online.

Even while the peer-to-peer networks were exchanging millions of songs daily, radio broadcasts continued to be an important medium for listeners and new technologies continued to evolve. Sirius Satellite Radio and XM Satellite Radio represent the radio industry's first major technological change since the popularization of FM radio in the 1970s: the creation of a third broadcast medium, transmitted by satellite, now taking its place alongside AM and FM on the radio dial. Satellite radio broadcasters transmit well over 100 discrete, radio channels to subscribers in digital sound.

A long-felt, but heretofore unfulfilled need exists in the radio and music industries for a technology that satisfies the way consumers enjoy music. Music listening may be divided into two main categories: (1) acquisition of new favorites; and (2) enjoyment of existing favorites. Radio broadcasting excels in the former category while peer-to-peer networks excel in the latter. Consumers listen to radio broadcasts to gain exposure to new music titles, particularly under the genre of the station. Once a consumer hears a music title they enjoy, they want to acquire it. Prior to music piracy on the Internet, the consumer would go to a music store and purchase the title. Even more recently, a user may now legally download a selection of titles available from authorized online distributors such as the “iTunes Music Store” offered by Apple Computer, Inc. However, a consumer listening to a traditional radio broadcast may not always obtain the necessary information to identify the music title. Furthermore, the consumer must engage in a substantial effort to obtain the music title by visiting a music store, logging into an online system to legally purchase the content or even engaging in illegal file sharing to download the content.

What is needed in the art is a system that enables consumers to contemporaneously purchase music heard over radio broadcasts and have the content delivered to them automatically.

U.S. Pat. No. 6,563,805 to Ma et al. describes a device for prepaid recording of digital audio signals. The patent describes a method wherein encrypted music is sent to a receiver which prevents recording of the audio content (col. 2, lines 16-24). The receiver holds a “Smartcard” which keeps track of the user's account balance (co. 2, lines 24-26). If the balance in the account is sufficient the encrypted data is decrypted by the receiver and can then be recorded by the user (col. 2, lines 26-31).

International Publication No. WO 00/31906 and related European Patent Application No. 99119395.4 to Sony Electronic, Inc., hereinafter the '906 application, describe a method and system for interactive digital radio broadcasting and a method and device for transmitting, receiving, and transferring said digital information, respectively. The '906 application describes a method and system wherein contextual information is broadcast along with the audio content (col. 4, lines 6-11). The contextual and audio content are then parsed and made available to the user (col. 4, lines 12-18). Additionally, a memory card is used to store the contextual information for later retrieval to facilitate ordering or recording of the audio content (col. 4, lines 32-35). This method requires the coupling of the audio content and additional information in the data stream.

U.S. Pat. No. 6,564,003 to Marko et al. describes a method and apparatus for creating a composite data stream containing multiple channels of content. The '003 method as described allows a user to record the entire data stream and select the desired content through an apparatus which de-multiplexes the data by accessing the header information which identifies where in the composite stream the desired content resides (col. 3, lines 1-5).

U.S. Pat. No. 6,347,216 to Marko et al. describes a method for providing geographic specific services via a satellite communication network. The system uses a terrestrial transponder which sends a signal containing identification information (col. 2, lines 25-30). The satellite then recognizes the signal and transmits predetermined geographic-specific content to the corresponding receiver (col. 2, lines 35-49).

### SUMMARY OF INVENTION

The present invention is a method of identifying an individual piece of media content substantially contemporaneously with the broadcast of the content. The content may be audio or video. Video content may include, but is not limited to, music videos, movies, documentaries, sitcoms, reality television, commercials, news broadcasts. Audio content may include, but is not limited to music, comedy, news, documentaries, commercials and call-in shows. The video may be broadcast on broadcast television, satellite television and cable television. The audio may be broadcast on terrestrial radio, satellite radio, satellite television and cable television.

A media broadcast database is provided whereby media content is identified by an automated software process. In some cases the automated software process may be manually programmed to store the broadcast times and content for each channel or station delivering the media content.

Alternatively, the automated software process may detect and identify the media content from a library of preexisting content. For example, Audible Magic of Los Gatos, Calif. provides audio fingerprinting technology that can identify over 3.5 million recorded songs as described in U.S. Pat. No. 5,918,223, the specification of which is incorporated herein by reference. Nielsen Broadcast Data Systems (BDS) operates in the U.S. and Canada as the world's leading provider of over-the-air music monitoring. Using pattern recognition technology, BDS can identify more than one million songs played on more than 1,100 radio stations in real time in 130 markets throughout the U.S. As a radio station plays a song, BDS technology identifies the song and logs the exact time, date, and station for that play. Shazam Entertainment Ltd out of London provides song detection technology that operates through a mobile device. However, it requires the execution of pattern recognition technology for each user request.

A request is received for the individual piece of media content substantially contemporaneous with its broadcast. The request identifies who is making the request and what station the requestor is exposed to (i.e., either listening or viewing). The identity of the requestor forms a requestor identity field. Determining the requestor identity field may be accomplished by a number of mechanisms. In one embodiment of the invention, the requestor initiates the process by dialing a telephone number. A caller identification string (CID) is generated establishing the identity of the caller. The CID data may be queried against a preexisting requestor table to determine the biographical information on the requestor including, but not limited to, name, address, age, locale, telephone number, email address, SMS address, prior request history and the like. Alternatives to CID data include prompting for touch tone entry on the telephone (DTMF signals) or prompting for speech which is then recognized by a software process.

In one embodiment of the invention, a system may be implemented to only handle requests for a single station. Thus, all that is required is the identity of the requester. However, in an anticipated embodiment of the invention, requests that may encompass a plurality of stations are handled. Dialed number identification service (DNIS) is a telephone service that identifies for the receiver of a call the number that the caller dialed. DNIS is commonly used on toll-free lines. Multiple toll-free lines may point to the same destination and DNIS tells which number was called. Accordingly, in the present invention, a unique telephone for each station is established. DNIS passes DTMF signals to the system to determine which station the requestor desires. This is particularly advantageous for cell phone users since nearly all cellular phones have an address book of preexisting numbers. Many cell phones accommodate voice-activated dialing. Thus, if a requestor regularly listens to 93.3 WFLZ out of Tampa, Fla., the requestor would program in the station's toll-free request line into their telephone. Upon hearing the song they want, they simply “speed-dial” the number. Their identity is automatically authenticated via the CID data and the DNIS data indicates that the station requested was 93.3. Thus, all that is required is for the telephone to be dialed. No user intervention is necessary beyond making the telephone connection.

This embodiment includes the steps of establishing the requestor identity field by CID data, establishing the station field by DNIS data whereby a caller dials a predetermined number associated with a station broadcasting the music recording as it is played, CID data identifies and authenticates the caller and DNIS data determines which station the caller was listening to at the time of the call wherein no caller intervention is required to process the request other than dialing the predetermined number.

On some systems, CID data may not be available. Accordingly, the requestor may need to key in his or her identity by DTMF or by speech. The identity may be a PIN, telephone number or user ID. It is preferred that the identity be associated with an integer value. If the CID data is not ascertainable, then the system prompts the user for the CID data or some other requestor identity value. In the event that telephone numbers are not uniquely assigned to stations and channels, then the user may be prompted to enter, either by DTMF or by speech, the station identifier. An interactive voice response system (IVR) may be established to obtain the station field. Systems like Nielsen's BDS monitor well over one thousand channels in real time. Accordingly, there are stations with identical frequencies in different locations. For example, there are at least twenty stations across the United States using the 93.3 frequency. Accordingly, an embodiment of the invention is to associate the CID data with a locale. A metro station area array is associated with the locale and a subset of the entire plurality of stations available is grouped within the metro station area array. The IVR system automatically configures its activity in anticipation that the station field will be extracted from the subset of the plurality of stations within the metro station area. Thus, if the CID information indicates the call is originating from the Tampa Bay area in Florida, the IVR system will assume that a user that keys in 933 on a touch tone phone or speaks “ninety three point three” wants the content playing on 93.3 WFLZ out of Tampa and not 93.3 KUBE out of Seattle, Wash. Another advantage of localizing the CID information is that local advertisers may participate in delivering their message to the requester.

As the request is initiated in real-time, the incoming system generates a timestamp value associated with the time the request was received. The broadcast database is queried using the channel field (the station identification) and the timestamp value to identify the content. The query results are returned to a destination associated with the requestor identity field. The destination may include an simple mail transport protocol (SMTP) email address, a simple messaging service (SMS) address, a software-accessible store, a compact disc processing entity, a cellular device, a portable digital music player, a land-line telephone, a fax machine or a set-top cable device. The query results may include the identity of the content such as content title and performer. In addition, the query results may contain a digital reproduction of the content itself.

Query results that are delivered by SMTP email may include links to purchase or secure the media content. SMS would typically only provide the identity of the content since attachments on SMS are not readily available on most SMS-capable devices. A client-side software application may run in the background on the requestor's personal computer whereby the media content is downloaded to the computer using the client-side software application responsive to a request. The query results trigger an event on the client-side computing device to automatically obtain the individual piece of media content.

Multiple requests may be queued up until sufficient content exists to burn it onto a music CD, data CD, music DVD, video DVD or data DVD. Demographic information determined from preexisting data on the requestor, from the requestor's CID information, or simply from the content requested may be incorporated into the disc thereby providing targeted advertising to the requestor.

At least one embodiment of the invention anticipates a method of doing business whereby the targeted advertising subsidizes the cost to the requestor, if not providing the service for free. Thus, advertisers are able to provide information on their products and services with more precision and consumers are able to obtain the media content they desire for minimal or no cost. Another advantage of this method is that consumers are likely to replay the content multiple times, thus re-exposing the consumer to the advertisers' messages.

Individual pieces of media content are categorized according to a content profile. An advertising presentation associated with the content profile is established and the advertising presentation is included with the query results according to the content profile of the individual piece of media content identified. In another embodiment broadcast channels are categorized according to a format profile. An advertising presentation is associated with the format profile included with the query results according to the format profile of the individual piece of media content identified.

Demographic information may be obtained on a requestor associated with the requestor identity field and a plurality of advertising presentations are categorized according to demographic information. An advertising presentation is selected according to the demographic information of the requestor and included with the query results according to the requestor identity field associated with the requestor.

### BRIEF DESCRIPTION OF DRAWINGS

FIG. 1 is a diagrammatic view of an embodiment of the invention showing a single request for media content.

FIG. 2 is a diagrammatic view of an embodiment of the invention showing multiple requests for media content placed into a request queue and executed on a predetermined time schedule.

FIG. 3 is a diagrammatic view of an embodiment of the invention showing multiple requests for media content placed into a request queue and executed responsive to the identification of the media content by an automated software process.

FIG. 4 is a diagrammatic view of an embodiment of the invention wherein advertising content is selected responsive to a plurality of variables including requester demographics, the channel the requester was exposed to, the broadcast time of the content and the identity of the content itself.

FIG. 5 is a diagrammatic view of an embodiment of the invention wherein CID and DNIS data from incoming telephone requests correlate to requestor identity fields and channel fields respectively.

FIG. 6 is a screen shot of a login interface for configuring an embodiment of the invention.

FIG. 7 is a screen shot of a user menu interface listing FM and Satellite/Network stations listened to by the requestor.

FIG. 8 is a screen shot of a search interface for finding various stations in different areas and broadcast mediums.

FIG. 9 is a screen shot of a user registration process according to an embodiment of the invention.

FIG. 10 is a screen shot of a background software process event log according to an embodiment of the invention utilizing CID requestor identification and DTMF station selection.

FIG. 11 is a screen shot of a request queue according to an embodiment of the invention.

FIG. 12 is a screen shot of an email delivery of music content information with a link to purchase the content from a third party source.

### DETAILED DESCRIPTION OF PREFERRED EMBODIMENT OF INVENTION

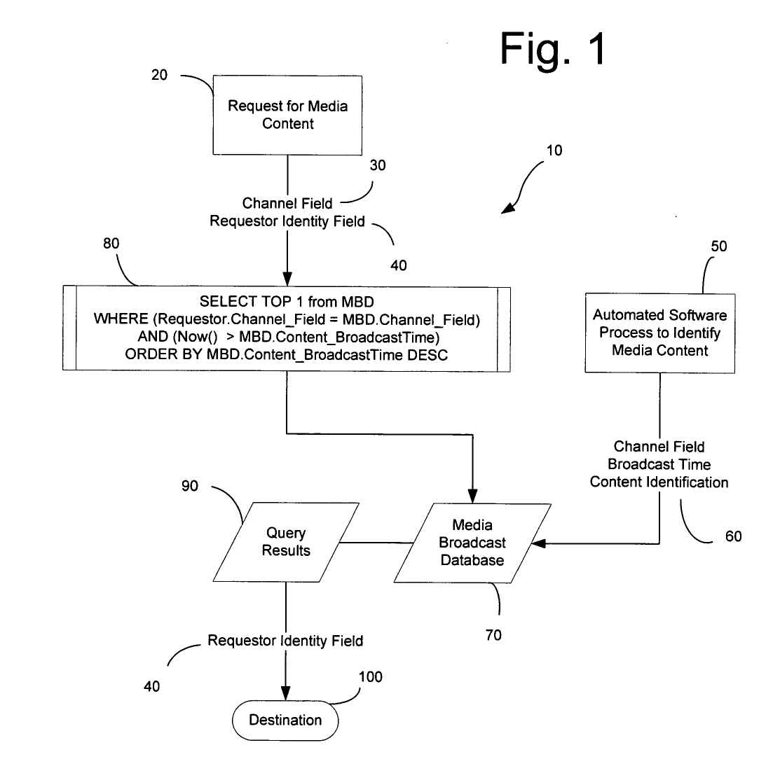

In FIG. 1, an embodiment of the invention is denoted generally as numeral 10. Request for media content 20 is executed containing channel field 30 and requester identity field 40. Channel field 30 may be associated with the channels on a cable television or the stations on a FM radio. Requestor identity field 40 may be any key value to associate the request with an end user or subscriber. Requestor identity field 40 is preferably a primary key integer value from which relevant data is extracted by a table lookup. However, other types of unique values such as telephone numbers or email addresses may be used for requester identity field 40.

Automated software process 50 monitors broadcast mediums to determine when identifiable content is broadcast on a particular channel or station and when it was initiated. It should be noted that automated software process 50 may be a background service that extracts manually entered data relating to broadcast schedules and is not restricted to content “fingerprinting” where a portion of the broadcast is sampled and compared against preexisting records. Automated software process 50 provides media content broadcast data 60 to media broadcast database 70. Media content broadcast data 60 includes the channel or station that broadcast the media content, the time in which it was broadcast and an identification of the content.

Database query 80 is executed against media broadcast database 70 according to channel field 30 and requestor identity field 40. Database query 80 automatically inserts a timestamp value upon receipt of the request and compares the timestamp value against the broadcast time in media content broadcast data 60. Query results 90 are produced and sent to destination 100 determined by requestor identity field 40.

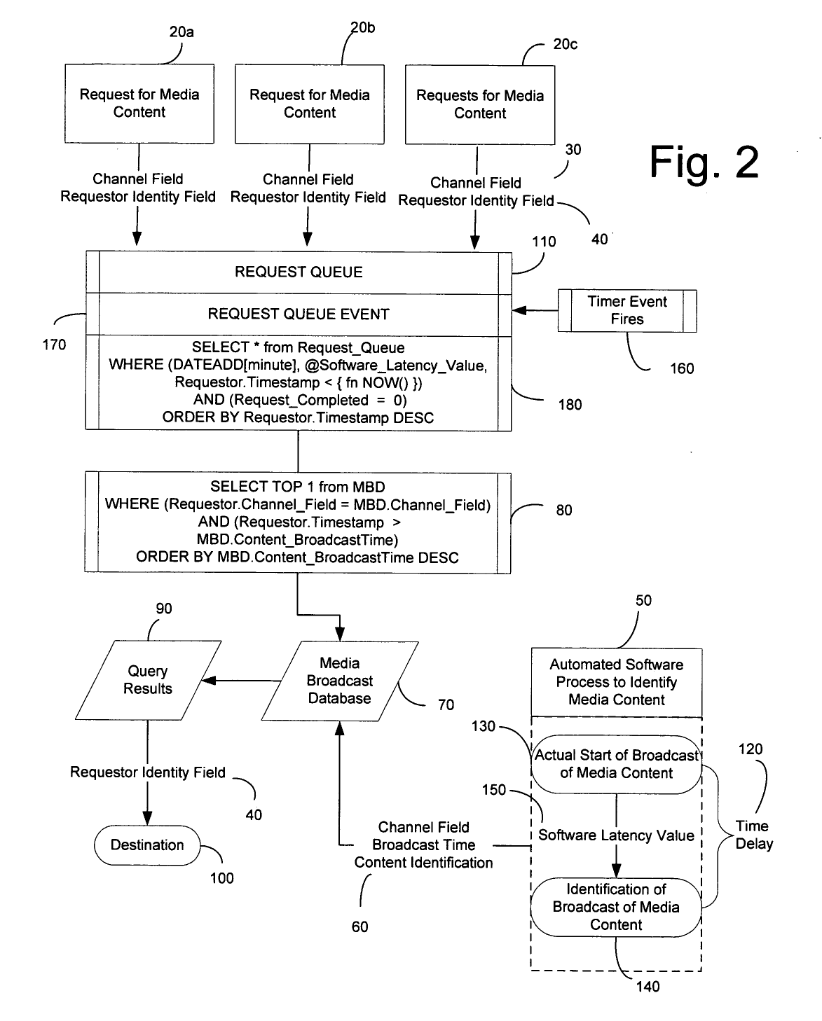

FIG. 2 illustrates an embodiment of the invention adapted to handle a plurality of concurrent requests 20a-20c which are stored in request queue 110. In the case of media content fingerprinting, time delay 120 exists between actual start of broadcast of media content 130 and identification of broadcast of media content 140. The difference between actual start 130 and identification 140 produces software latency value 150. If query 80 is executed before automated software process 50 can identify the media content, then query results 90 will produce no records. Accordingly, the present invention provides a timer event 160 which fires then resets upon a lapse of software latency value 150 time associated with time delay 120. Request queue event 170 fires responsive to timer event 160 and executes request queue query 180 which returns all pending requests at least as old as time delay 120 embodied in software latency value 150. Database query 80 is then executed for all pending requests returned by request queue query 180. Pending requests that are successfully executed against database query 80 are marked completed by an update command.

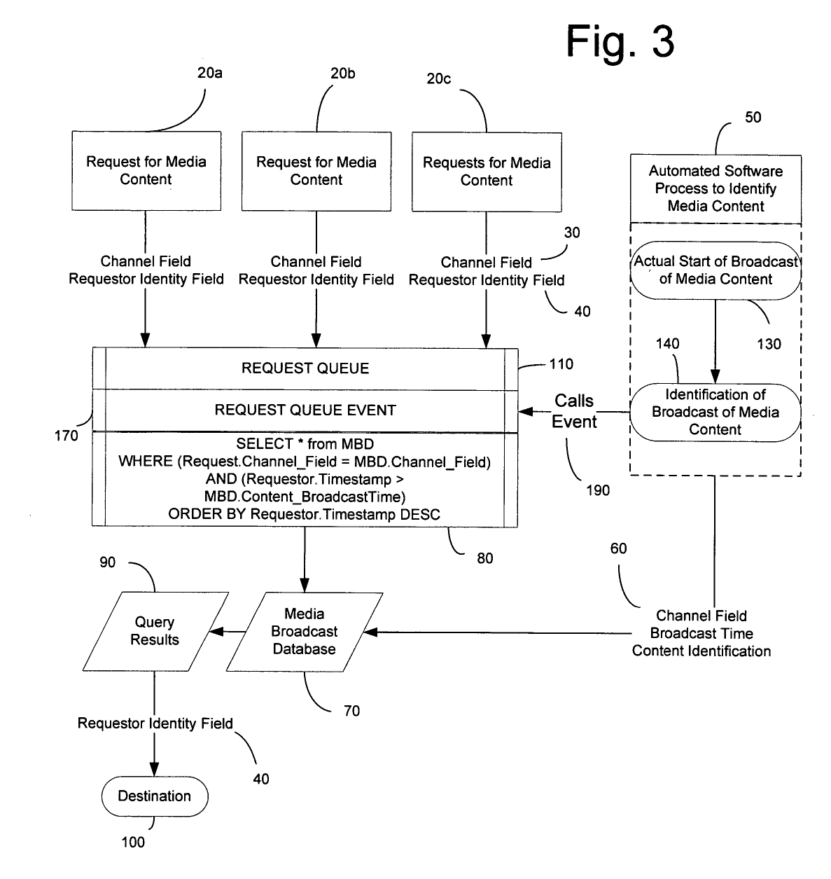

In FIG. 3, an alternative embodiment of the invention is provided. In some cases, a request for media content 20 is received before the media content is identified by automated software process 50. Rather than queue up all pending requests until a predetermined time period passes (i.e., time delay 120), identification of broadcast 140 returns a call 190 to request queue event 170. Thus, as soon as the media content is identified, all preexisting requests are processed. However, in other cases, requests 20 are received after call 190 and therefore should be processed according to the workflow of FIG. 2.

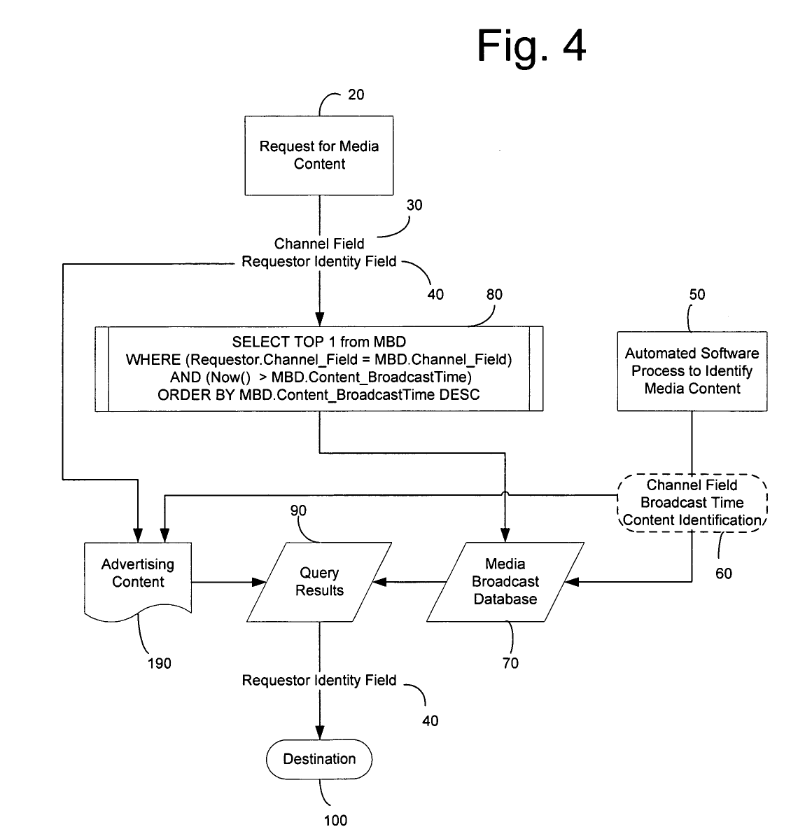

In FIG. 4, channel field 30, requester identity field 40, broadcast time and content identification (collectively 60) determine advertising content 190 attached to query results 90. Channel field 30 may provide demographic information on the requester. For example, advertising for a concert featuring country singers would be more likely successful on a requestor that listens to a country music station over another requestor that listens to jazz music. Request identity field 40 may provide detailed information on the address, occupation, and preferences of the requester. Request identity field 40 is linked to a requestor subscriber record which stores, among other fields, destination 100. Content identification 60 may provide information to better help select advertising content 190 whereby a listener of pop music may be more likely to purchase an album by another pop artist. Even broadcast time may help determine appropriate advertising content 190. Requests made late at time might be presumably made by adults wherein day-time requests may presumably include both adults and children.

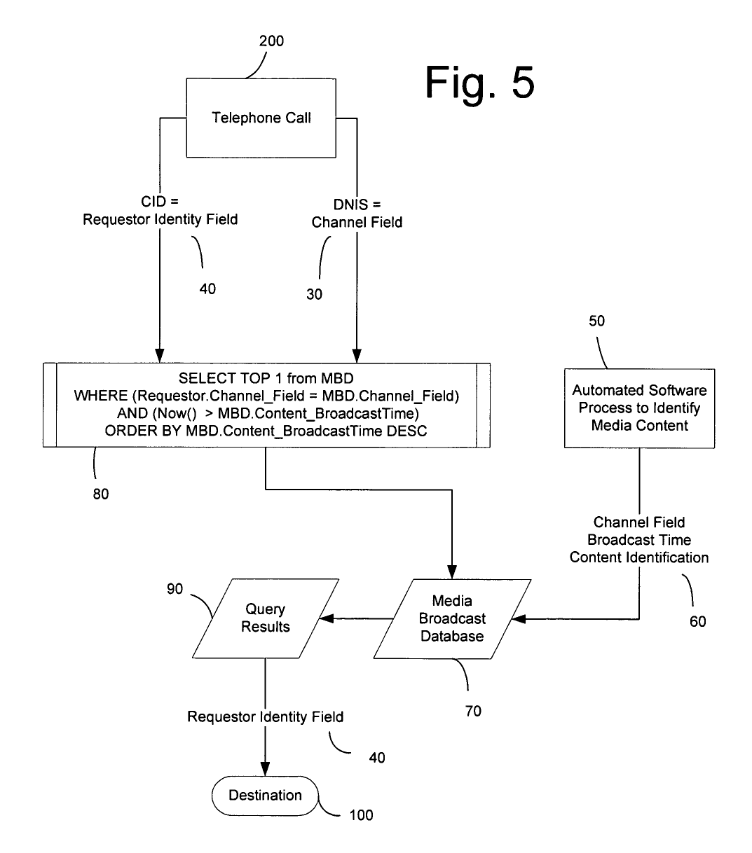

An authentication scheme is provided in FIG. 5 wherein telephone request 200 transmits both CID and DNIS information. For each station or channel, a separate incoming telephone number is provided. CID data is cross-referenced to requestor identity field 40. DNIS is cross-referenced to channel field 30. No user input is required. The requestor's identity is automatically verified by CID. Requestor's selection of channel or station is automatically determined by DNIS. Thus, rather than requiring requestor to depress tone-tone keys or speak out loud the station or channel identity, the mere act of dialing a determined number provided all the information needed. The authentication scheme is particularly appropriate for telephones that have speed dial memory and/or address books. Requestors need only find the appropriate phone number for the station they hear and then dial that number.

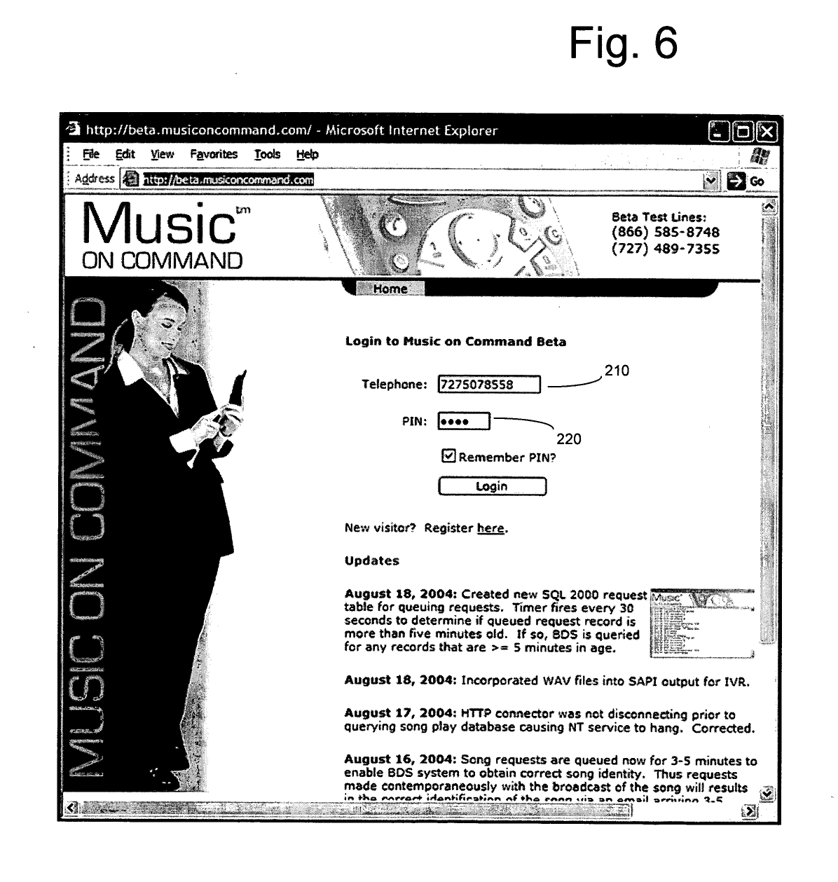

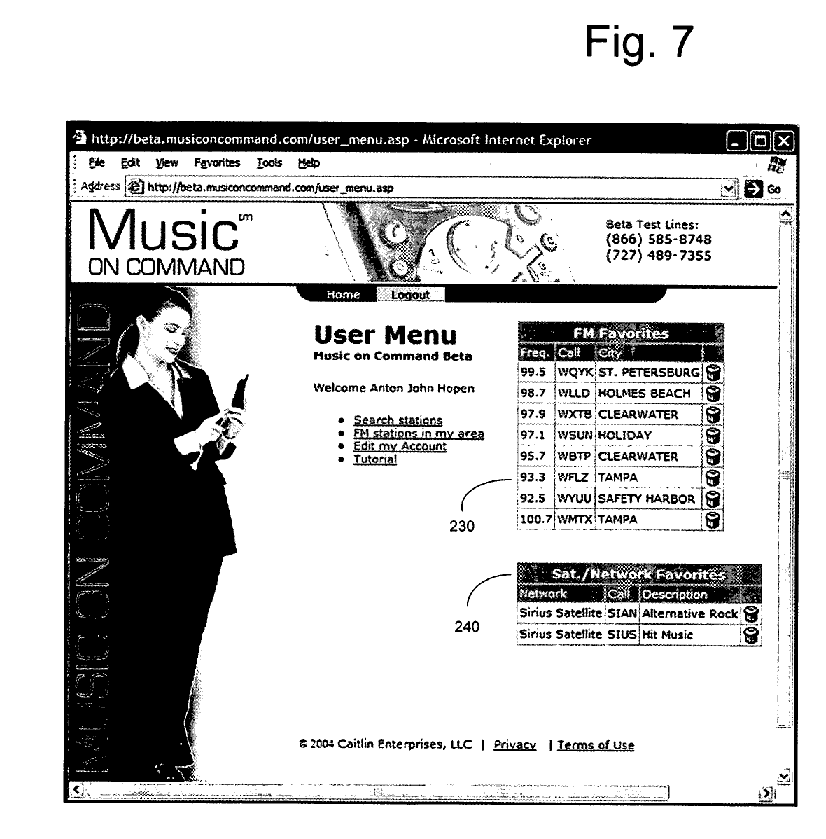

FIGS. 6-9 illustrate a web-based user interface for setting up a requestor's account. FIG. 6 shows a login screen. Requestor telephone number 210 may be used as primary identity field 40. An advantage of this method is that the authentication scheme of FIG. 5 may be easily deployed. Requestor PIN 220 is provided for security purposes. Preferably, an integer-restricted PIN is utilized in the event it must be keyed into a touch-tone telephone for authentication purposes. In FIG. 7, FM favorites 230 are enumerated by frequency, call sign and city. An advantage of establishing favorites is that IVR systems that intake requests may be automatically configured to those favorites. For example, there are at least twenty FM radio stations in the United Stations that broadcast under the 93.3 frequency. Since requestor is primarily in one locale, only station, 93.3 WFLZ out of Tampa, is included on FM favorites. When prompted for the identity of the station or channel, requestor does not need to designation which of the twenty 93.3 frequency stations is the selection. Rather, the IVR system defaults to FM favorites 230. In addition to FM favorites 230, Satellite/Network favorites 240 may also be provided.

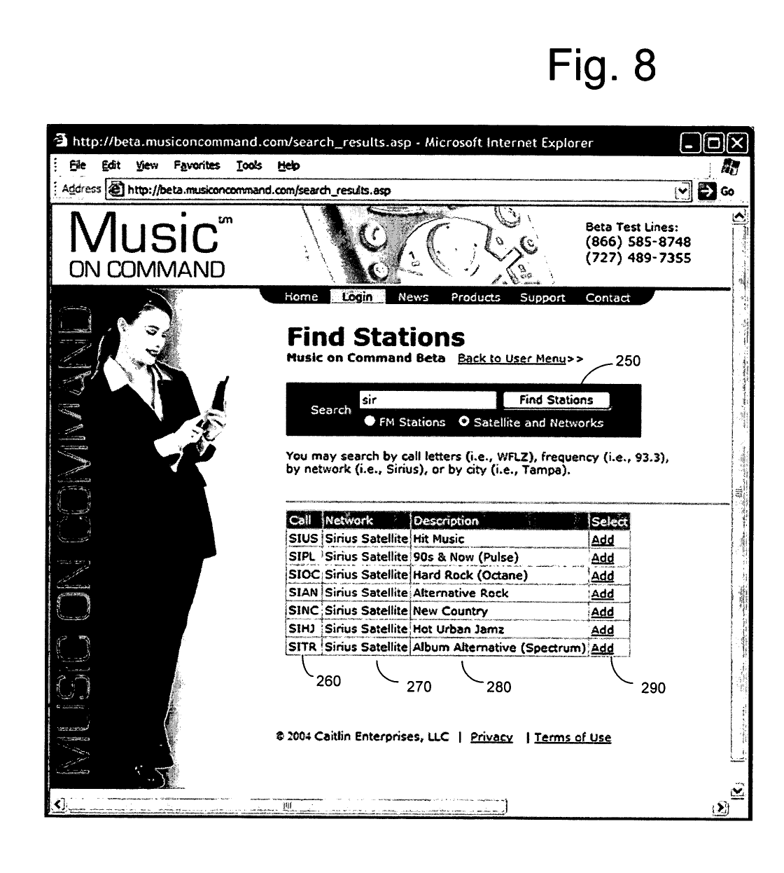

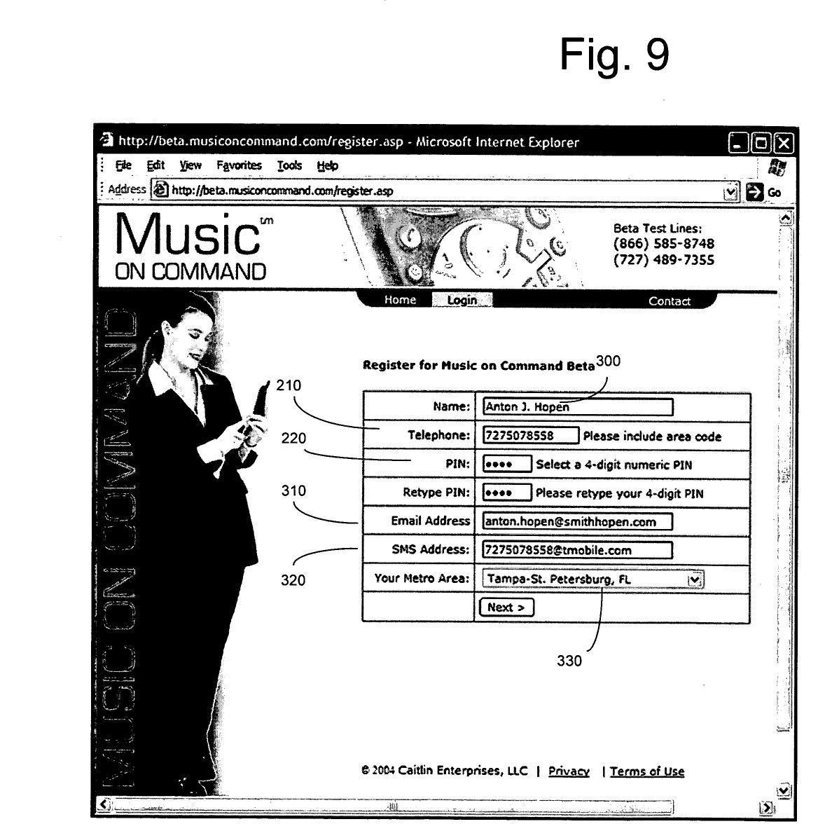

FIG. 8 illustrates search mechanism 250 for finding stations or channels of interest. Search mechanism 250 returns station call letters 260, network identity 270, station description 280 and favorites add selection 290. In FIG. 9 requestor name 300, requester telephone 210, requestor PIN 220, requester email 310, requestor SMS 320 and requestor metro area 330 are editable and stored via the web-based interface.

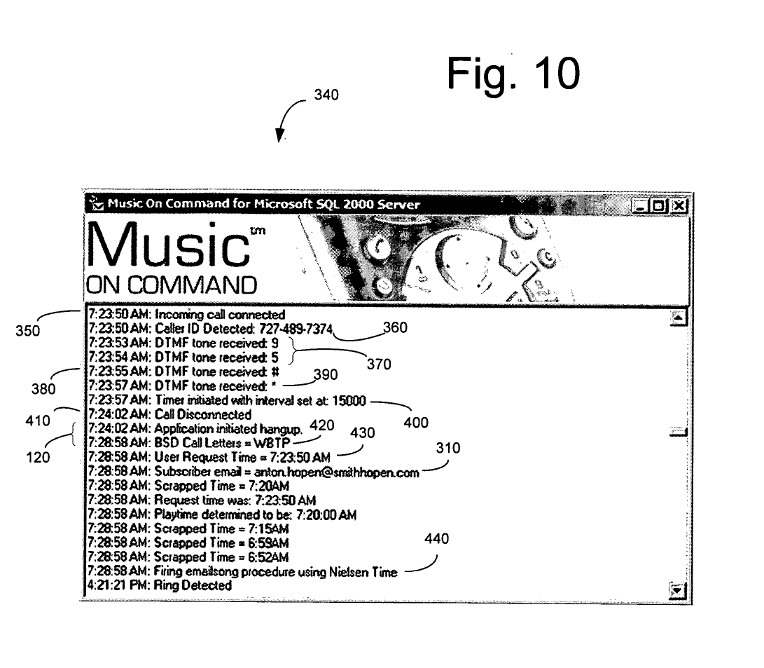

FIG. 10 is background software process event log 340 according to an embodiment of the invention utilizing CID requestor identification and DTMF station selection. Incoming call connect 350 establishes a communications pathway. CID detection 360 determines requestors telephone number 210 which authenticates the identity of requestor and brings up requestor's FM favorites 230. DTMF array for frequency ID 370 is received indicating the station selection starts with the integers “9” and “5.” As the only station frequency that matches “95” is WBTP out of Clearwater on requestor's FM favorites 230, WBTP is the presumptive station and processing may continue automatically. Alternatively, requestor may issue DTMF frequency ID send command 380 to select a station. In the event requestor selected “97” a prompt would generate warning requester that two stations in FM favorites 230 start with “97,” namely 97.9 WXTB and 97.1 WSUN. Requestor would have to key in “979” for WXTB or “971” for WSUN, the decimal points being ignored. Once the desired station is requested DTMF station confirmation command 390 completes the transaction sending requestor's selections to request queue 110. Timer initiation 400 is executed and set at software latency value 150. Call disconnect 410 is executed. As noted from the timestamps on the left margin, the incoming call was connected at 7:23:50 AM and completed at 7:24:02 AM. Thus, the entire transaction took twelve seconds. Time delay 120 for automated software process 50 in this example is predetermined to be five minutes. Thus, at 7:28:58 AM, station ID 420 and requester timestamp value 430 are queried against media broadcast database 70. Query results 90 are returned and destination 100 is set to be request email 310. Transmission to destination 440 is executed.

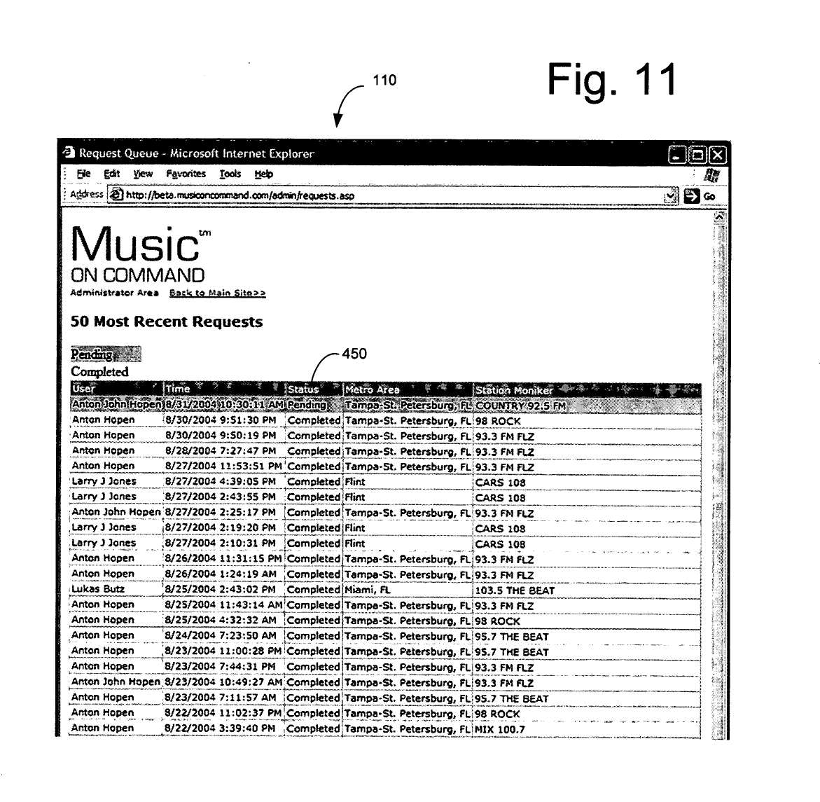

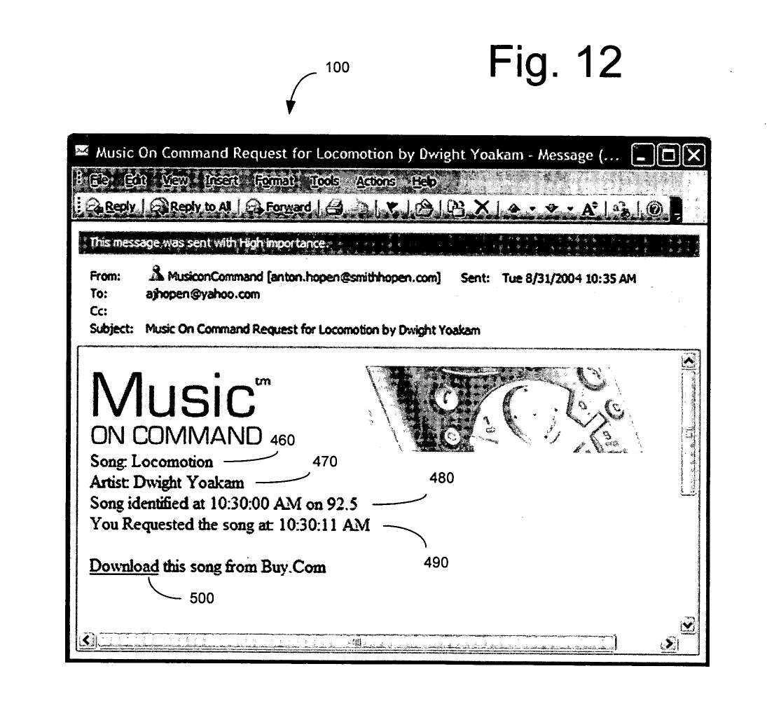

FIG. 11 shows request queue 110 in a web-based display. Request queue status 450 is provided in columnar format. FIG. 12 shows destination 100 as request email 310. Information sent to designation 100 includes song title 460, song recording artist 470, song identification timestamp 480 and request timestamp 490. Purchase link 500 is provided with a hyperlink dynamically constructed from song title 460 and song recording artist 470 to send requestor directly to the appropriate URL.

### REFERENCE TABLE FOR DRAWINGS

| | |
|---|---|
| 10 | The invention generally |
| 20 | Request for media content |
| 30 | Channel field |
| 40 | Requestor identity field |
| 50 | Automated software process to identify |
| | media content |
| 60 | Media content broadcast data |
| 70 | Media broadcast database |
| 80 | Database query |
| 90 | Query results |
| 100 | Query result destination |
| 110 | Request queue |
| 120 | Time delay |
| 130 | Actual start of broadcast media content |
| 140 | Identification of broadcast media content |
| 150 | Software latency value |
| 160 | Timer event |
| 170 | Request queue event |
| 180 | Request queue query |
| 190 | Advertising content |
| 200 | Telephone request |
| 210 | Requestor telephone number |
| 220 | Requestor pin |
| 230 | FM favorites |
| 240 | Satellite/Network favorites |
| 250 | Search mechanism |
| 260 | Station call letters |
| 270 | Network identity |
| 280 | Station description |
| 290 | Favorites add selection |
| 300 | Requestor name |
| 310 | Requestor email |
| 320 | Requestor SMS |
| 330 | Requestor metro area |
| 340 | Event log |
| 350 | Incoming call connect |
| 360 | CID detection |
| 370 | DTMF array for frequency ID |
| 380 | DTMF frequency ID send command |
| 390 | DTMF station confirmation command |
| 400 | Timer initiation |
| 410 | Call disconnect |
| 420 | Call letter ID |
| 430 | Requestor timestamp value |
| 440 | Destination transmission |
| 450 | Request queue status |
| 460 | Song title |
| 470 | Song recording artist |
| 480 | Song identification timestamp |
| 490 | Request timestamp |
| 500 | Purchase link |

Definition List 1

| Term | Definition |
|---|---|
| ANI | Automatic Number Identification is |
| | a telephone network feature that |
| | passes the number of the phone |
| | the caller is using to the call |
| | center, real-time. ANI is used by |
| | long distance carriers. |
| CID | Caller Identification is a system by |
| | which the calling-party number |
| | (and sometimes the name and |
| | called-number) is transmitted to |
| | the called party. CID is used by |
| | local telephone companies. |
| DNIS | Dialed Number Identification |
| | Service is a telephone service that |
| | identifies for the receiver of a call |
| | the number that the caller dialed. |
| SMTP | Simple Mail Transfer Protocol is a |
| | TCP/IP protocol used in sending |
| | and receiving e-mail. |

What is claimed is:

1. A method of identifying an individual piece of media content substantially contemporaneously with the broadcast of the content comprising the steps of: establishing a media broadcast database whereby media content is identified by an automated software process as media content is broadcast from a plurality of different broadcast channels; receiving a request for the individual piece of media content substantially contemporaneous with its broadcast, the request comprising a channel field and a requester identity field; generating a timestamp value associated with the time the request was received; querying the broadcast database using the channel field and the timestamp value to identify the content; and returning the query results to a destination associated with the requester identity field.

2. The method of claim 1 further comprising the steps of establishing a predetermined software latency value representative of the lag time required to identify media content from its initial broadcast; and queuing requests according to the software latency value prior to querying the broadcast database whereby requests remain pending until the automated software process has identified the individual piece of media content according to the query.

3. The method of claim 1 further comprising the steps of queuing requests for media content that has not yet been identified by the automated software process; establishing a request queue query adapted to search pending queued requests that have timestamp values subsequent to an identification of media content for the associated station field; and executing the request queue query responsive to the identification of media content whereby the query results are returned as soon as the individual piece of media content is identified by the automated software process.

4. The method of claim 1 wherein the media content is selected from the group consisting of audio and video content.

5. The method of claim 4 wherein the audio comprises music broadcast on a medium selected from the group consisting of terrestrial radio, satellite radio, satellite television and cable television.

6. The method of claim 4 wherein the video comprises music videos broadcast on a medium selected from the group consisting of satellite television and cable television.

7. The method of claim 4 wherein the audio comprises content selected from the group consisting of music, comedy, news, documentaries, commercials and call-in shows.

8. The method of claim 4 wherein the video is selected from a group consisting of movies, documentaries, sitcoms, reality television, commercials, and news broadcasts.

9. The method of claim 1 wherein the query results include purchase information for secure a digital reproduction of the individual piece of media content.

10. The method of claim 1 wherein the query results include a digital reproduction of the individual piece of media content.

11. The method of claim 1 wherein the query results trigger an event on a client-side computing device to automatically obtain the individual piece of media content.

12. The method of claim 1 further comprising the steps of: categorizing individual pieces of media content according to a content profile; establishing an advertising presentation associated with the content profile; and including the advertising presentation with the query results according to the content profile of the individual piece of media content identified.

13. The method of claim 1 further comprising the steps of: categorizing broadcast channels according to a format profile; establishing an advertising presentation associated with the format profile; and including the advertising presentation with the query results according to the format profile of the individual piece of media content identified.

14. The method of claim 1 further comprising the steps of: obtaining demographic information on a requestor associated with the requestor identity field; categorizing a plurality of advertising presentations according to demographic information; selecting an advertising presentation according to the demographic information of the requestor; and including the advertising presentation with the query results according to the requestor identity field associated with the requestor.

15. The method of claim 1 wherein the destination is selected from the group consisting of an SMTP address, an SMS address, a software-accessible store, a compact disc processing entity, a cellular device, a portable digital music player, a land-line telephone, a fax machine, and a set-top cable device.

16. A method of identifying a music recording substantially contemporaneously with the broadcast of the music recording comprising the steps of:
establishing a music recording broadcast database whereby music recordings are identified by an automated software process as music recordings are broadcast from a plurality of different stations; receiving a request for the music recording substantially contemporaneous with its broadcast, the request comprising a station field and a requestor identity field; generating a timestamp value associated with the time the request was received; querying the music recording broadcast database using the channel field and the timestamp value to identify the music recording; and returning the query results to a destination associated with the requestor identity field.

17. The method of claim 16 wherein the request is received through a telephone line connection.

18. The method of claim 17 wherein CID data transmitted with the telephone line connection establishes the requestor identity field.

19. The method of claim 17 further comprising the steps of establishing a unique telephone number for each station in the plurality of different stations and capturing DNIS data transmitted with the telephone line connection to establish the station field.

20. The method of claim 17 further comprising the steps of generating a voice prompt to accept DTMF input on the telephone line connection to establish the requestor identity field.

21. The method of claim 17 further comprising the steps of generating a voice prompt to accept DTMF input on the telephone line connection to establish the station field.

22. The method of claim 17 further comprising the steps of generating a voice prompt to accept speech input on the telephone line connection to establish the requestor identity field.

23. The method of claim 17 further comprising the steps of generating a voice prompt to accept speech input on the telephone line connection to establish the station field.

24. The method of claim 19 further comprising the steps of establishing the requestor identity field by CID data, establishing the station field by DNIS data whereby a caller dials a predetermined number associated with a station broadcasting the music recording as it is played, CID data identifies and authenticates the caller and DNIS data determines which station the caller was listening to at the time of the call wherein no caller intervention is required to process the request other than dialing the predetermined number.

25. The method of claim 18 further comprising the step of establishing an IVR system for establishing the station field.

26. The method of claim 25 further comprising the steps of associating the CID data with a locale; establishing a metro station area array associated with the locale; and grouping a subset of the plurality of stations within the metro station area array whereby the IVR system automatically configures its activity in anticipation that the station field will be extracted from the subset of the plurality of stations within the metro station area.

27. The method of claim 18 further comprising the steps of: obtaining demographic information on a requestor associated with the requestor identity field from the CID data; categorizing a plurality of advertising presentations according to demographic information; selecting an advertising presentation according to the demographic information of the requestor; and including the advertising presentation with the query results according to the requestor identity field associated with the requester.

28. A method of identifying a music recording substantially contemporaneously with the broadcast of the music recording comprising the steps of: establishing a music recording broadcast database whereby music recordings are identified by an automated software process as music recordings are broadcast from a plurality of different stations; receiving a request for the music recording substantially contemporaneous with its broadcast by a telephone call, the request comprising a station field established by DNIS and a requester identity field established by CID; obtaining demographic information on a requestor associated with the requester identity field from the CID data; categorizing a plurality of advertising presentations according to demographic information; selecting an advertising presentation according to the demographic information of the requestor; generating a timestamp value associated with the time the request was received; querying the music recording broadcast database using the station field and the timestamp value to identify the music recording; and returning the query results and the advertising presentation to a destination associated with the requestor identity field.
